(19) United States
(12) Patent Application Publication
(10) Pub. No.: US 2012/0268810 A1
(43) Pub. Date: Oct. 25, 2012

(54) INFRARED RAY REFLECTIVE SUBSTRATE

(75) Inventors: Yutaka Ohmori, Osaka (JP); Kazuaki Sasa, Osaka (JP); Toshitaka Nakamura, Osaka (JP)

(73) Assignee: NITTO DENKO CORPORATION, Ibaraki-shi, Osaka (JP)

(21) Appl. No.: 13/497,402

(22) PCT Filed: Nov. 9, 2010
(86) PCT No.: PCT/JP2010/069897

§ 371 Date: Mar. 21, 2012

(30) Foreign Application Priority Data
Nov. 18, 2009 (JP) 2009-262825

(51) Int. Cl. F21V 9/04

(52) U.S. Cl. 359/359

(57) ABSTRACT

There is provided an infrared ray reflective substrate including an infrared ray reflective layer, a protective layer disposed on a surface of the infrared ray reflective layer and a transparent substrate that supports the infrared ray reflective layer from a rear surface side thereof, wherein the protective layer is formed from a polycycloolefin layer.

### TECHNICAL FIELD

The present invention relates to an infrared ray reflective substrate in which a protective layer disposed on an infrared ray reflective layer is formed from a polycycloolefin layer so as to keep emissivity at low level and to exhibit excellent heat resistance and weather resistance.

### BACKGROUND ART

There have been heretofore known infrared ray reflective substrates configured by disposing an infrared ray reflective layer between a transparent substrate and a protective layer. For instance, JP Laid-open Application Publication No. 2000-334876 discloses a multilayer body having heat ray reflective function wherein a heat ray reflective layer, a photocatalytic function layer and a surface protective film are laminated on a surface of a transparent thermoplastic resin film in this order and a self-adhesive layer and a release film are laminated on the other surface thereof in this order.

When in use, an infrared ray reflective multilayer body such as above is adhered to a building window, a vehicle window, etc. so as to improve cooling or heating effect or adhered to a window of a refrigerated show case so as to improve cold reserving effect.

In this connection, the protective film of the above multilayer body is typically made from a polyethylene terephthalate film, an acrylic ultraviolet hard coating agent or the like so as to enhance scratch resistance and weather resistance of its infrared ray reflective layer.

### PRIOR ART DOCUMENT

Patent document 1: JP Laid-open Application Publication No. 2000-334876

### DISCLOSURE OF THE INVENTION

### Problem to be Solved by the Invention

In a case where the above-mentioned polyethylene terephthalate film or acrylic ultraviolet hard coating agent is used for the protective layer of the infrared ray reflective substrate, infrared ray is likely to be absorbed in the region of 5 μm to 25 μm wavelength, due to its inherent chemical constitution with plenty of C═O groups, C—O groups and aromatic groups. Therefore, when the infrared ray reflective substrate employs a protective layer made from a polyethylene terephthalate film or an acrylic ultraviolet hard coating agent containing plenty of the above-mentioned functional groups, the protective layer absorbs light directly radiated thereon as well as light reflected by the infrared reflective layer, whereby rise in emissivity is induced and sufficient heat insulating property cannot be obtained. Consequently, there is left a problem such as reduction in heat insulating property of the infrared ray reflective substrate.

The present invention has been made to resolve the above described conventional problem. The object of the present invention is to provide an infrared ray reflective substrate capable of keeping emissivity at low level by forming a protective layer of an infrared ray reflective layer from a polycycloolefin layer, so as to exhibit excellent heat resistance and weather resistance.

### Means for Solving the Problem

To achieve the object thereof, an infrared ray reflective substrate of claim 1 includes an infrared ray reflective layer, a protective layer disposed on a surface of the infrared ray reflective layer, and a transparent substrate that supports the infrared ray reflective layer from a rear surface side thereof, wherein the protective layer is formed from a polycycloolefin layer.

As mentioned at claims 2 through 4, thickness of the protective layer is preferably within a range from 0.5 μm to 100 μm, more preferably within a range from 1 μm to 50 μm, and even more preferably within a range from 1 μm to 10 μm.

Further, as mentioned at claim 5, it is preferable that the protective layer is formed from a polynorbornene layer.

Further, as mentioned at claim 6, it is preferable that normal emissivity of the infrared ray reflective substrate is 0.1 or lower.

Further, as mentioned at claim 7, the protective layer may be adhered to the transparent substrate via a transparent adhesive layer of which thickness is 1 μm or thinner.

### Effect of the Invention

Of the infrared ray reflective substrate of the present invention, the protective layer disposed on the infrared ray reflective layer is formed from a polycycloolefin layer. In view of chemical constitution of the polycycloolefin layer, the layer is primarily constituted by carbon atom and hydrogen atom. Therefore, stretching vibration of its C—H group eventually appears at shorter wavelength side (mid infrared region) of infrared ray. Thereby, emissivity of the infrared ray reflective substrate can be kept at low level. Consequently, there can be realized the infrared ray reflective substrate exhibiting weather resistance and heat resistance property.

### BRIEF DESCRIPTION OF THE DRAWINGS

FIG. 1 is a cross sectional view for schematically illustrating an example of an infrared ray reflective substrate directed to a present embodiment.

FIG. 2 is a cross sectional view for schematically illustrating another example of the infrared ray reflective substrate.

### EXPLANATION OF REFERENCES

1 infrared ray reflective substrate

2 transparent substrate

3 infrared ray reflective layer

4 protective layer

5 adhesive layer

### BEST MODE FOR CARRYING OUT THE INVENTION

Specific embodiments of an infrared ray reflective substrate according to the present invention will be described below in detail with reference to the drawings.

[Infrared Ray Reflective Substrate]

An infrared ray reflective substrate of the present embodiment includes an infrared ray reflective layer, a protective layer disposed on a surface of the infrared ray reflective layer, and a transparent substrate that supports the infrared ray reflective layer from a rear surface side thereof, wherein the protective layer is formed from a polycycloolefin layer.

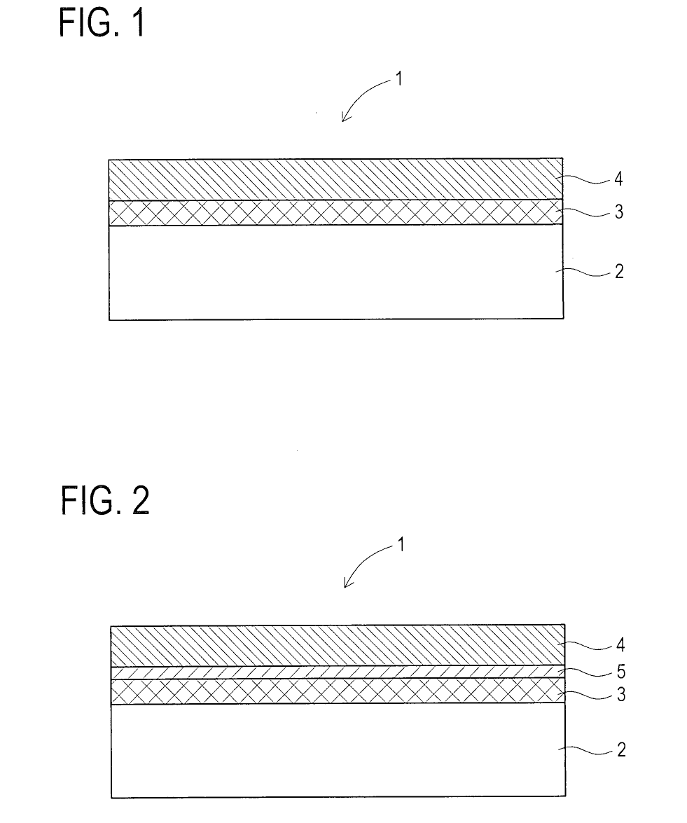

One example is shown in FIG. 1. Specifically, an infrared ray reflective substrate 1 is constituted by a transparent substrate 2, an infrared ray reflective layer 3 disposed on a surface of the transparent substrate 2 with its rear surface being supported by the transparent substrate 2 and a protective layer 4 formed from a polycycloolefin layer and disposed on an upper surface of the infrared ray reflective layer 3.

Another example is shown in FIG. 2. Specifically, an infrared ray reflective substrate 1 is constituted by a transparent substrate 2, an infrared ray reflective layer 3 disposed on a surface of the transparent substrate 2 with its rear surface being supported by the transparent substrate 2 and a protective layer 4 formed from a polycycloolefin layer and adhered on an upper surface of the infrared ray reflective layer 3 via a transparent adhesive layer 5.

In the example shown in FIG. 1, only the protective layer 4 formed from a polycycloolefin layer is directly disposed on the infrared ray reflective layer 3. As will be described later, a polycycloolefin layer can be directly adhered and disposed on the infrared ray reflective layer 3 as long as the layer has thickness of 10 μm or thinner.

Further, in the example shown in FIG. 2, the protective layer 4 formed from a polycycloolefin layer is adhered on the upper surface of the infrared ray reflective layer 3 via the transparent adhesive layer 5. In this example, it is preferable that thickness of the transparent adhesive layer 5 should be adjusted to 1 μm or thinner.

By constituting the infrared ray reflective substrate 1 as shown in FIG. 1 or FIG. 2, emissivity thereof can be kept at low level.

In the above infrared ray reflective substrate 1, there may be disposed another layer at the opposite surface side of the infrared reflective layer, for instance, a self adhesive layer may be disposed there.

Of the above infrared ray reflective substrate, visible light transmission based on JIS (Japan Industrial Standard) A 5759-2008 (adhesive films for glazings) is preferably 50% or higher, more preferably, 70% to 94%. Of the above infrared ray reflective substrate, normal emissivity based on JIS R 3106-2008 (testing method on transmittance, reflectance and emittance of flat glasses and evaluation of solar heat gain coefficient) is preferably 0.4 or lower, more preferably, 0.2 or lower, and even more preferably, 0.01-0.15.

[Infrared Ray Reflective Layer]

The infrared ray reflective layer used for the infrared ray reflective substrate directed to the present embodiment allows transmittance of visible light and reflects infrared ray. Of the above infrared ray reflective layer itself, the visible light transmission based on JIS A 5759-2008 is preferably 50% or higher, and the normal emissivity based on JIS R 3106-2008 is preferably 0.1 or lower.

The above-mentioned infrared ray reflective layer is typically constituted by laminating plural thin films such as metallic thin film made of gold, silver or the like and high-reflective-index thin films made of titanium dioxide, ziruconium dioxide, etc.

As material for forming the above metallic thin films, gold, silver, copper, alloy of those metals are used, for instance. Thickness of the metallic thin film is adjusted, preferably, within a range of 5 nm to 1000 nm so as to enhance both visible light transmission and infrared ray reflectivity.

The above-mentioned high-reflective-index thin film has reflective index preferably within a range of 1.8 to 2.7. As material for forming the above high-reflective-index thin films, indium tin oxide, TiO₂, ZrO₂, SnO₂, In₂O₃, etc. are used. Thickness of the high-reflective-index thin film is adjusted, preferably, within a range of 20 nm to 80 nm.

For forming the above metallic thin films and the high-reflective-index thin films, sputtering method, vacuum deposition method, plasma CVD (chemical vapor deposition) method, etc. can be adopted, for instance.

[Protective Layer]

The protective layer used for the infrared ray reflective substrate of the present embodiment is made of a polycycloolefin layer. Here in this description, the term “polycycloolefin” corresponds to a polymer or a copolymer obtained by using an alicyclic compound inclusive of double bond. The above-mentioned polycycloolefin is preferably polynobornene that exhibits a little absorption of infrared region, excellent weather resistance and heat resistance. As specific polymer of the above, there may be used commercially available ones such as ZEONEX, ZEONOR, etc. (both registered trademarks), products of ZEON Corporation.

Since its basic chemical constitution consists of carbon atom and hydrogen atom, the above polycycloolefin layer exhibits the characteristics such as a little absorption of far infrared region. Accordingly, by properly adjusting its thickness, minimum transmissivity at the wavelength range of 5 μm to 25 μm (far infrared region) can be made high (e.g., 50% or higher).

Thickness of the polycycloolefin layer is preferably within a range from 0.5 μm to 100 μm, more preferably within a range from 1 μm to 50 μm, and even more preferably within a range from 1 μm to 10 μm. In a case where its layer thickness is made 10 μm or thinner, a polycycloolefin layer can be applied on a surface of the infrared ray reflective layer without using adhesive agent so as to realize tightly-adhered layers of the polycycloolefin layer and the infrared ray reflective layer. Therefore, an infrared ray reflective substrate with less emissivity can be obtained.

In a case where the layer thickness is made 100 μm or thicker, the polycycloolefin layer's absorption of infrared region becomes apparent and poor heat insulating property is caused. In a case where thickness of the polycycloolefin layer is made 0.5 μm or thinner, deterioration is brought to a metallic film of the infrared ray reflective layer and weather resistance thereof gets poor consequently.

It is to be noted that the above polycycloolefin layer may include additives such as anti-oxidizing agent, antistatic agent, etc., other than polycycloolefin.

As the method for forming the above polycycloolefin layer, melt extruding method, solution cast method, etc. may be applied.

[Transparent Substrate]

The transparent substrate used for the infrared ray reflective substrate of the present embodiment is configured so as to have 80% or higher of visible light transmission. Thickness of the transparent substrate is not particularly restricted but it may be designed within a range from 10 μm to 150 μm, for instance.

Material for forming the above transparent substrate is a glass plate or a polymer film. Molding temperature of the above infrared ray reflective layer is high in many cases. Therefore, in a case where a polymer film is used for the transparent substrate, a polymer film with excellent heat resistance is preferable.

The examples of the above such preferable polymer films may be made from polyethylene terephtalate, polyethylene naphthalate, polyether ether ketone, polycarbonate, etc.

[Usage]

Usage of the inventive infrared ray reflective substrate is not particularly restricted. When used, the infrared ray reflective substrate may be preferably adhered to a building window, a vehicle window, a transparent case for accommodating and showing plants inside, a window of a refrigerated showcase, etc., for instance, so as to improve cooling or heating effect or to protect from rapid temperature change.

(Embodiment)

[Embodiment 1]

An infrared ray reflective layer is formed by laminating on a 125 μm-thick polyethylene terephtalate film (“Diafoil U300E125”, the product of Mitsubishi Plastic Inc.), the following films in the following order in accordance with DC magnetron spattering method: a 50 nm-thick SiOₓ film; a 35 nm-thick indium tin oxide (abbreviated as ITO, herein after) film; a 13 nm-thick Ag—Au alloy (Au 3 Wt %) film; a 35 nm-thick ITO film; and a 200 nm-thick SiO, film.

A polynorbornene solution (“ZEONOR”, product of ZEON Corporation) dissolved into cyclooctane is applied to a surface of the infrared ray reflective layer and subsequently dried there so as to form a protective layer consisting of a 5.1 μm-thick polynorbornene layer. Table 1 shows a normal emissivity and weather resistance test result of the thus fabricated infrared ray reflective substrate of the embodiment 1 (about 130.4 μm gross thickness and 78% of visible light transmission).

[Embodiment 2]

Other than employing an 8.5 μm-thick polynorbornene layer as the protective layer, the infrared ray reflective substrate of the embodiment 2 is fabricated in similar with the fabrication manner of embodiment 1. Table 1 shows a normal emissivity and weather resistance test result of the thus fabricated infrared ray reflective substrate of the embodiment 2.

[Embodiment 3]

Other than employing a 23 μm-thick polynorbornene layer (“ZEONOR”, product of ZEON Corporation) as the protective layer and applying this layer on a surface of the infrared ray reflective layer with intervention of an 80 nm-thick polyester adhesive, the infrared ray reflective substrate of the embodiment 3 is fabricated in similar with the fabrication manner of embodiment 1. Table 1 shows a normal emissivity and weather resistance test result of the thus fabricated infrared ray reflective substrate of the embodiment 3.

[Embodiment 4]

Other than employing a 40 μm-thick polynorbornene layer (“ZEONOR”, product of ZEON Corporation) as the protective layer and applying this layer on a surface of the infrared ray reflective layer with intervention of an 80 nm-thick polyester adhesive, the infrared ray reflective substrate of the embodiment 4 is fabricated in similar with the fabrication manner of embodiment 1. Table 1 shows a normal emissivity and weather resistance test result of the thus fabricated infrared ray reflective substrate of the embodiment 4.

[Comparison 1]

Other than employing a 23 μm-thick polyethylene terephthalate film (“Diafoil T609E25”, product of Mitsubishi Polyester Film Group) as the protective layer and applying this layer on a surface of the infrared ray reflective layer with intervention of an 80 nm-thick polyester adhesive, the infrared ray reflective substrate of the Comparison 1 is fabricated in similar with the fabrication manner of embodiment 1. Table 1 shows a normal emissivity and weather resistance test result of the thus fabricated infrared ray reflective substrate of the comparison 1.

[Comparison 2]

Other than employing a 4.9 μm-thick hard coating layer (“Acrylic Urethane Hard Coating PC1097”, product of DIC Corporation, which is applied on a surface of the infrared ray reflective layer and ultraviolet cured thereon) as the protective layer, the infrared ray reflective substrate of the comparison 2 is fabricated in similar with the fabrication manner of embodiment 1. Table 1 shows a normal emissivity and weather resistance test result of the thus fabricated infrared ray reflective substrate of the comparison 2.

[Comparison 3]

Other than employing a 6.1 μm-thick hard coating layer (“Organic-Inorganic Hybrid Hard Coating Opstar Z7540”, product of JSR Corporation, which is applied on a surface of the infrared ray reflective layer and ultraviolet cured thereon) as the protective layer, the infrared ray reflective substrate of the comparison 3 is fabricated in similar with the fabrication manner of embodiment 1. Table 1 shows a normal emissivity and weather resistance test result of the thus fabricated infrared ray reflective substrate of the comparison 3.

[Comparison 4]

Other than employing no protective layer (i.e., with the infrared ray reflective layer being exposed), the infrared ray reflective substrate of the comparison 4 is fabricated in similar with the fabrication manner of embodiment 1. Table 1 shows a normal emissivity and weather resistance test result of the thus fabricated infrared ray reflective substrate of the comparison 4.

TABLE 1

| | | | Infrared Ray | |
|---|---|---|---|---|
| | Protective Layer | | Reflective Substrate | |
| | | Thickness | | Weather |
| | Material | (μm) | Normal Emissivity | Resistance |
| Embodiment 1 | PNB | 5.1 | 0.09 | ◯ |
| Embodiment 2 | PNB | 8.5 | 0.11 | ◯ |
| Embodiment 3 | PNB | 23 | 0.18 | ◯ |
| Embodiment 4 | PNB | 40 | 0.31 | ◯ |
| Comparison 1 | PET | 23 | 0.85 | ◯ |
| Comparison 2 | HC Agent | 4.9 | 0.40 | ◯ |
| Comparison 3 | HC Agent | 6.1 | 0.59 | ◯ |
| Comparison 4 | None | None | 0.02 | X |

In the above table 1, PNB, PET, HC Agent respectively stand for the below indicated items.
PNB: Polynorbornene
PET: Polyethylene terephthalate
HC Agent: hard coating agent

[Evaluation]

It can be observed from the embodiments 1 through 4 that the infrared ray reflective substrates each employing 20 μm or thinner thickness of a polycychloorefin layer as protective layer have 0.2 or lower of normal emissivity and exhibit excellent heat insulating property. Particularly, in case of employing 10 μm or thinner thickness of a polynorbornene layer, significantly excellent heat insulating property can be obtained (embodiments 1 and 2).

It can be observed from the comparison 1 that the employment of a polyethylene terephthalate film as the protective film makes normal emissivity of the infrared ray reflective substrate twice or more higher than that of infrared ray reflective substrates employing a polycychloorefin layer. The employment of hard coating agent as the protective film brings the comparisons 2 and 3 the same result as the comparison 1 (i.e., considerably high in normal emissivity thereof).

In case of employing no protective film at the comparison 4, such configured infrared ray reflective substrate is unusable outside due to poor weather resistance of its infrared ray reflective layer.

(Measuring Method in Embodiments and Comparisons)

[Measuring Method of Thickness]

For the cases of measuring 10 μm or thinner thickness of protective layers, a part of a protective layer has been peeled off so as to measure difference between gross thickness and protective-layer-absent thickness of an infrared ray reflective substrate by using a stylus profilemeter (“Dektak”, the product of Veeco Instruments Inc.) For the cases of measuring protective layers exceeding 10 μm in thickness, thickness thereof has been directly measured by using a digital micrometer (product of Mitutoyo Corporation).

[Measuring Method of Normal Emissivity]

By using a Fourier-transform infrared spectrometer (FT-1R, product of Varian Inc.) furnished with an angle-variable accessory, regular reflectance within a respect to 5 μm-25 μm wavelength range of infrared ray is measured so as to calculate normal emissivity in accordance with JIS R 3106-2008 (testing method on transmittance, reflectance and emittance of flat glasses and evaluation of solar heat gain coefficient).

[Weather Resistance Evaluation Method]

By using a xenon weathermeter (“X25”, product of Suga Test Instruments Co., Ltd.), there have been repeated a hundred cycles of weather resistance test each cycle of which consists of the below described test condition 1 and condition 2. After the hundred-cycle test, the condition of the infrared ray reflective substrate has been observed. The one found no deterioration in the infrared ray reflective layer has been evaluated as “ο” whereas the one found deterioration (migration of silver) has been evaluated as “X”.

<Condition 1 (Illumination & Rainfall)>
Time: 12 minutes, Illumination: 48W/m², Temperature: 38° C.,
Humidity: 95% RH

<Condition 2 (Illumination)>
Time: 48 minutes, Illumination: 48W/m², Temperature: 63° C.,
Humidity: 50% RH

[Visible Light Transmission Measurement Method]

By using a spectro-photometer (“U-4100”, product of Hitachi High-Technology Corporation), visible light transmission has been measured in accordance with JIS A 5759-2008 (adhesive films for glazings).

### INDUSTRIAL APPLICABILITY

The present invention makes it possible to provide an infrared ray reflective substrate capable of keeping emissivity at low level by forming a protective layer of an infrared ray reflective layer from a polycycloolefin layer, so as to exhibit excellent heat resistance and weather resistance.

1. An infrared ray reflective substrate comprising:
an infrared ray reflective layer;
a protective layer disposed on a surface of the infrared ray reflective layer; and
a transparent substrate that supports the infrared ray reflective layer from a rear surface side thereof,
wherein the protective layer is formed from a polycycloolefin layer.

2. The infrared ray reflective substrate according to claim 1, wherein thickness of the protective layer is within a range from 0.5 μm to 100 μm.

3. The infrared ray reflective substrate according to claim 2, wherein thickness of the protective layer is within a range from 1 μm to 50 μm.

4. The infrared ray reflective substrate according to claim 3, wherein thickness of the protective layer is within a range from 1 μm to 10 μm.

5. The infrared ray reflective substrate according to claim 1, wherein the protective layer is formed from a polynorbornene layer.

6. The infrared ray reflective substrate according to claim 1, wherein normal emissivity of the infrared ray reflective substrate is 0.4 or lower.

7. The infrared ray reflective substrate according to claim 1, wherein the protective layer is adhered to the transparent substrate via a transparent adhesive layer of which thickness is 1 μm or thinner.
